(19) United States
(12) Patent Application Publication
(10) Pub. No.: US 2021/0028636 A1
(43) Pub. Date: Jan. 28, 2021

(54) DOCKING SPEAKER WITH WIRELESS CHARGER

(71) Applicant: Belkin International, Inc., Playa Vista, CA (US)

(72) Inventors: DAVID KLEEMAN, Long Beach, CA (US); Erin Napolitano, Los Angeles, CA (US); Vince Razo, San Gabriel, CA (US); Robert Tang, Northridge, CA (US); Barry Sween, Santa Monica, CA (US)

(21) Appl. No.: 16/935,207

(22) Filed: Jul. 22, 2020

Related U.S. Application Data
(60) Provisional application No. 62/877,269, filed on Jul. 22, 2019.

(51) Int. Cl. H02J 7/00; H02J 50/00; H04R 1/02

(52) U.S. Cl. CPC H02J 7/0044; H04R 1/028; H02J 50/005

(57) ABSTRACT

A docking speaker includes a case enclosing a pair of push-push woofers located around two opposite lateral sides and outwardly facing away from each other in the transverse direction, a wireless charging module located between the pair of push-push woofers in the transverse direction and forming an upward oblique seating face on which the smart phone is adapted to be positioned, and a full range speaker located between the pair of push-push woofers in the transverse direction and aligned below the wireless charging module in the vertical direction when viewed along the front-to-back direction.

### BACKGROUND OF THE INVENTION

### 1. Field of the Invention

The invention relates to the docking speaker with the wireless charger thereon, and particular to the docking speaker with the speaker system intermixing with the wireless charger without substantial vibration due to the sound generated by the speaker.

### 2. Description of Related Art

Both U.S. Pat. Nos. 9,184,619 and 9,343,837 disclose the docking speaker with the wireless charger thereon for not only playing the music but also charging the smart phone wirelessly at the same time. To enhance the sound quality, the woofer is used in the speaker system of the docking speaker, and the woofer may introduce the relatively significant vibration during playing the music. Anyhow, the wireless charging is very susceptible to vibration which can shift the phone's position relative to the center of the charging coil. Notably, the charging efficiency depends on the phone being centered on the charging coil. In addition, the high volume associated with vibration may also cause the phone to move causing potential rattling noise. Both the aforementioned two patents fail to pay attention to this potential defect because both of them have the pair of speakers mounted upon the same side of the case which inevitably results in the vibration and this drawback gets worse when the speaker gets the high volume.

It is desired to have the docking speaker with the wireless charger thereon without substantial vibration due to the speaker system.

### SUMMARY OF THE INVENTION

A docking speaker includes a case enclosing a pair of push-push woofers located around two opposite lateral sides and outwardly facing away from each other, a wireless charging module located between the pair of push-push woofers in the transverse direction and forming an upward oblique seating face on which the smart phone is adapted to be positioned, and a full range speaker located between the pair of push-push woofers in the transverse direction and aligned below the wireless charging module in the vertical direction when viewed along the front-to-back direction. A first printed circuit board is located on a lower portion of the case and is connected with an external power wire. A second printed circuit board is located on an upper portion of the case in compliance with the oblique seating face and mechanically and electrically connected to the wireless charging module. A third printed circuit board is located on the upper portion of the case and in front of the second printed circuit board, and mechanically and electrically connected to the panel button and the microphone.

Other objects, advantages and novel features of the invention will become more apparent from the following detailed description when taken in conjunction with the accompanying drawings.

### BRIEF DESCRIPTION OF THE DRAWINGS

FIG. 1 is a front downward perspective view of a docking speaker according to the instant invention;

FIG. 2 is a rear downward perspective view of the docking speaker of FIG. 1;

FIG. 3 is cross-sectional view of the docking speaker of FIG. 1 to shown the arrangements of the internal parts;

FIG. 4 is a front downward exploded perspective view of the docking speaker of FIG. 1;

FIG. 5 is a further front downward exploded perspective view of the docking speaker of FIG. 4;

FIG. 6 is a rear upward exploded perspective view of the docking speaker of FIG. 5;

FIG. 7 is a front upward exploded perspective view of the docking speaker of FIG. 6;

FIG. 8 is a front downward exploded perspective view of an upper portion of the docking speaker of FIG. 1;

FIG. 9 is a rear upward exploded perspective view of the upper portion of the docking speaker of FIG. 1;

FIG. 10 is a rear downward perspective view of the docking speaker of FIG. 1 without the main body of the case;

FIG. 11 is a front downward exploded perspective of the docking speaker of FIG. 10; and

FIG. 12 is a rear upward exploded perspective view of FIG. 11.

### DETAILED DESCRIPTION OF THE PREFERRED EMBODIMENT

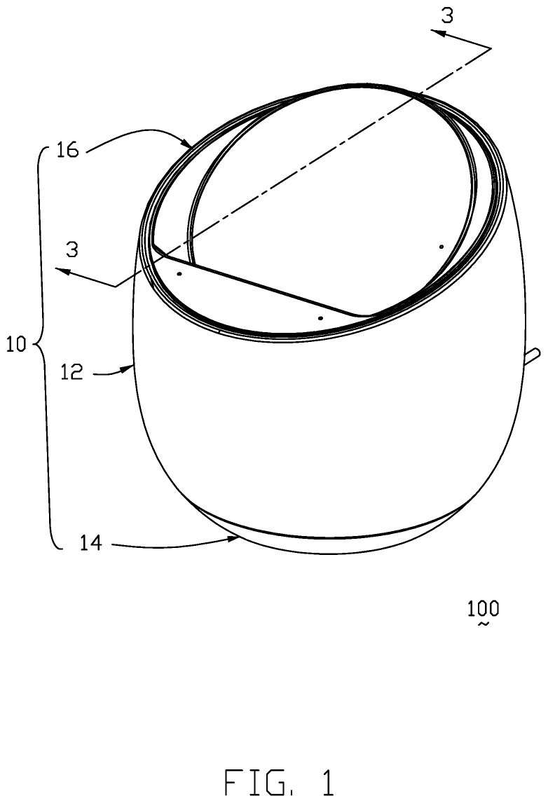

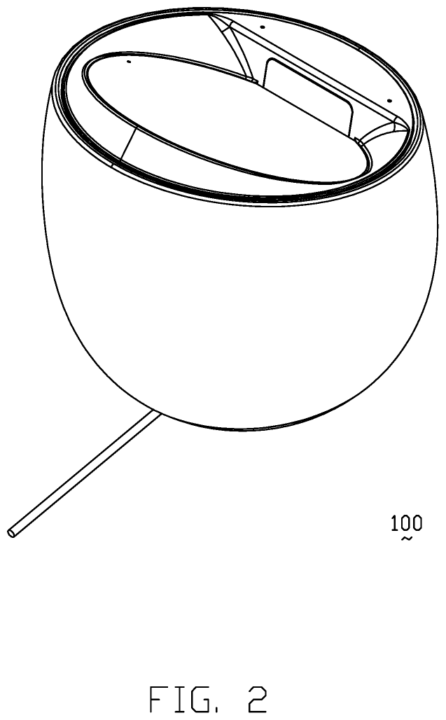

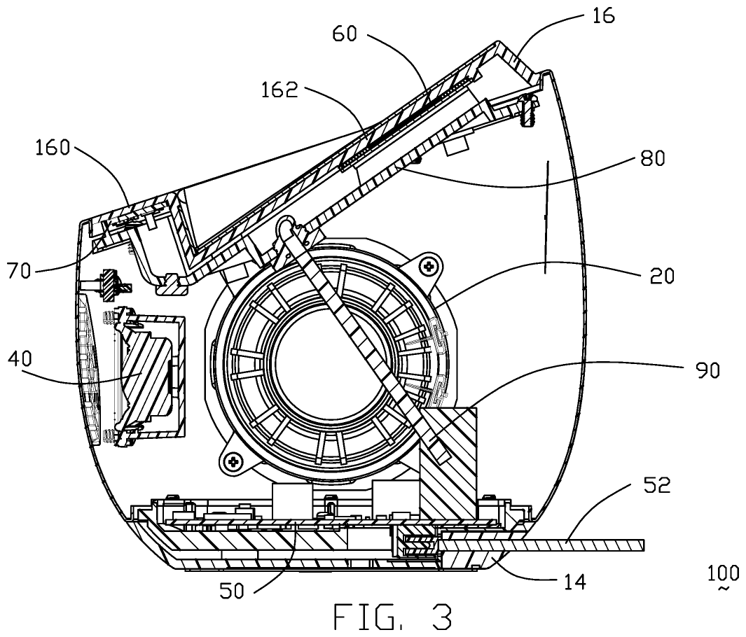

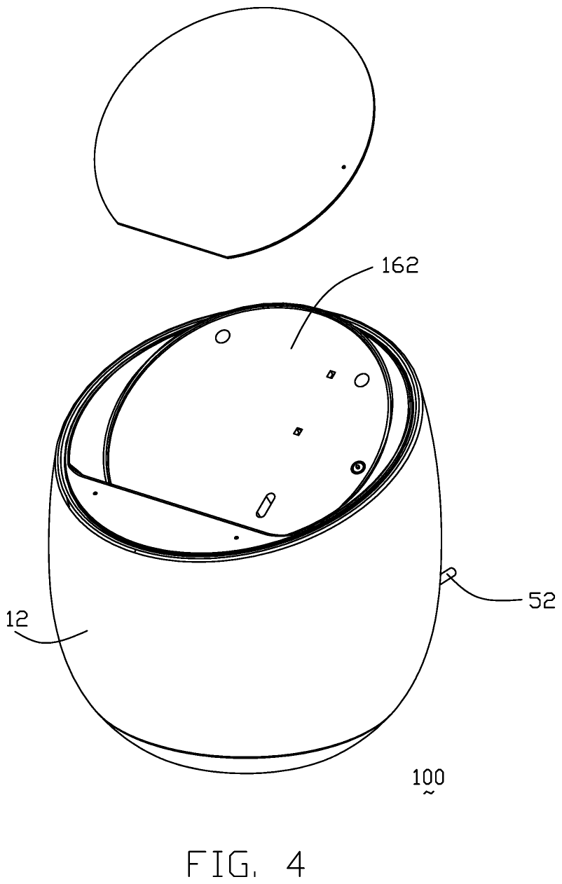

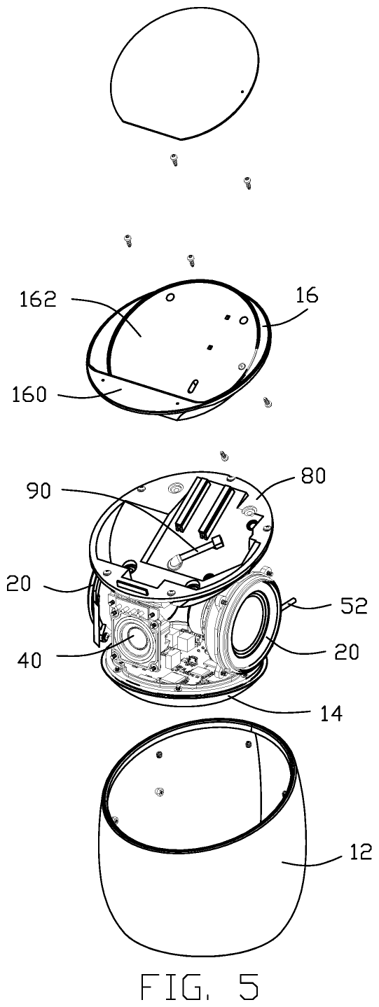

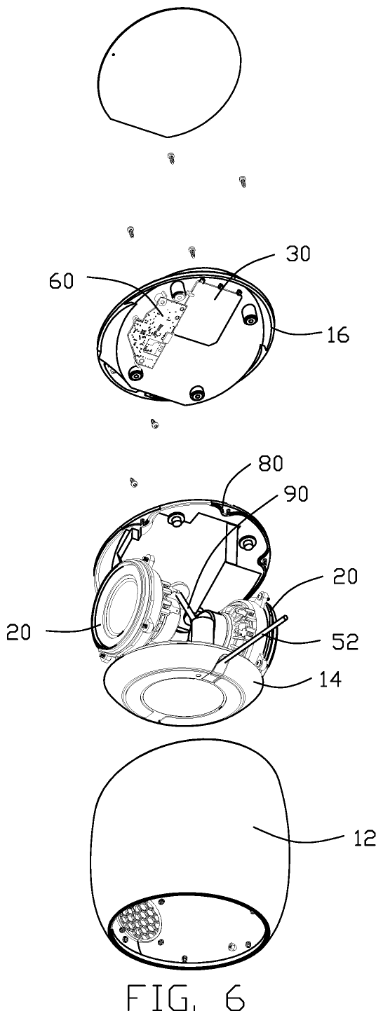

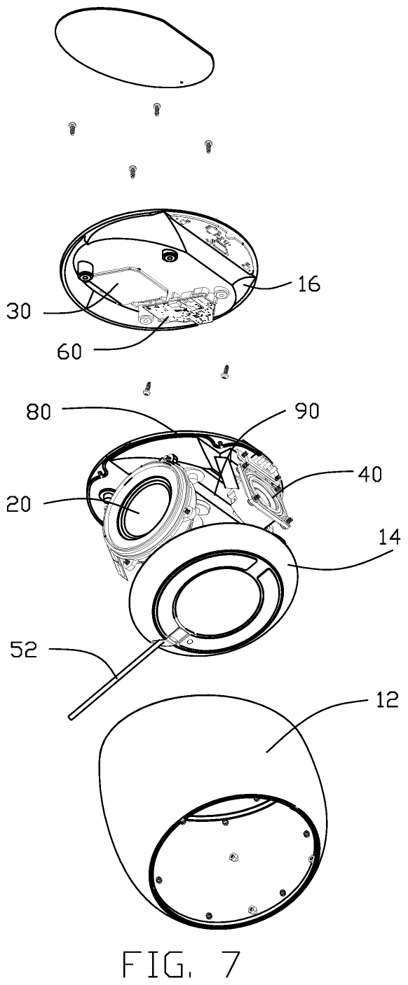

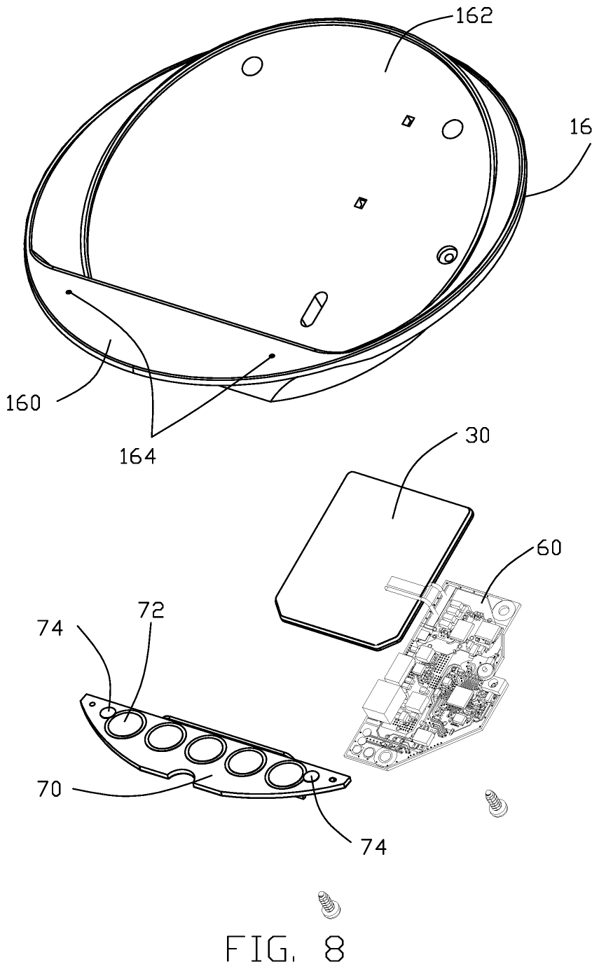

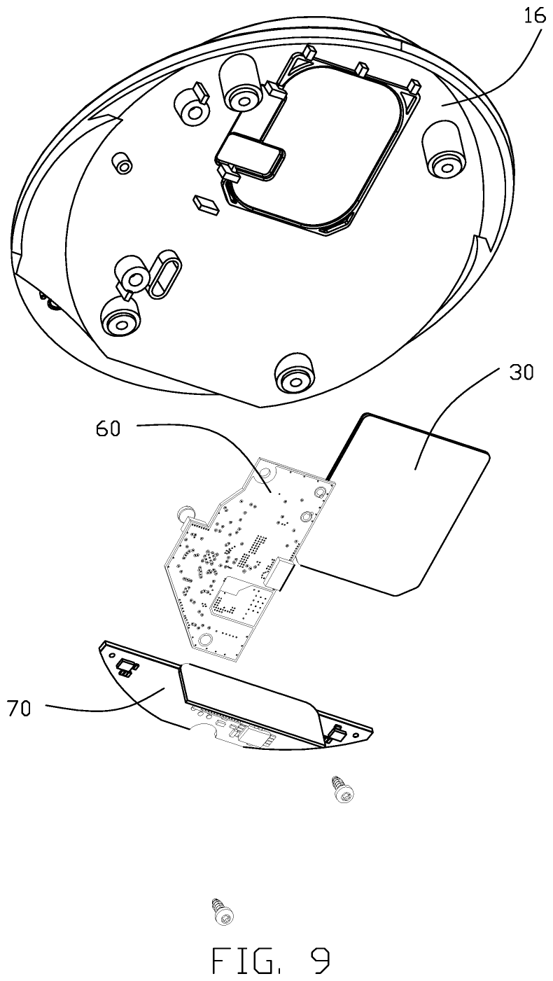

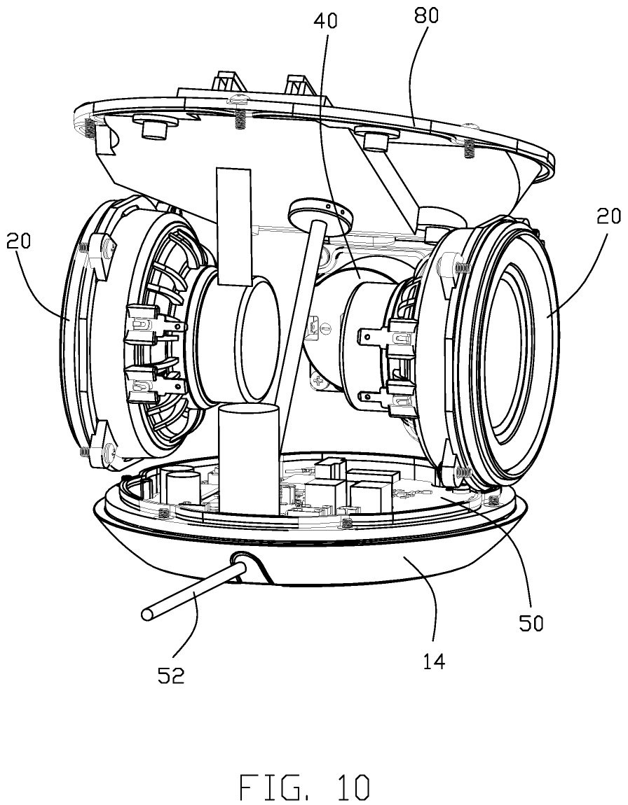

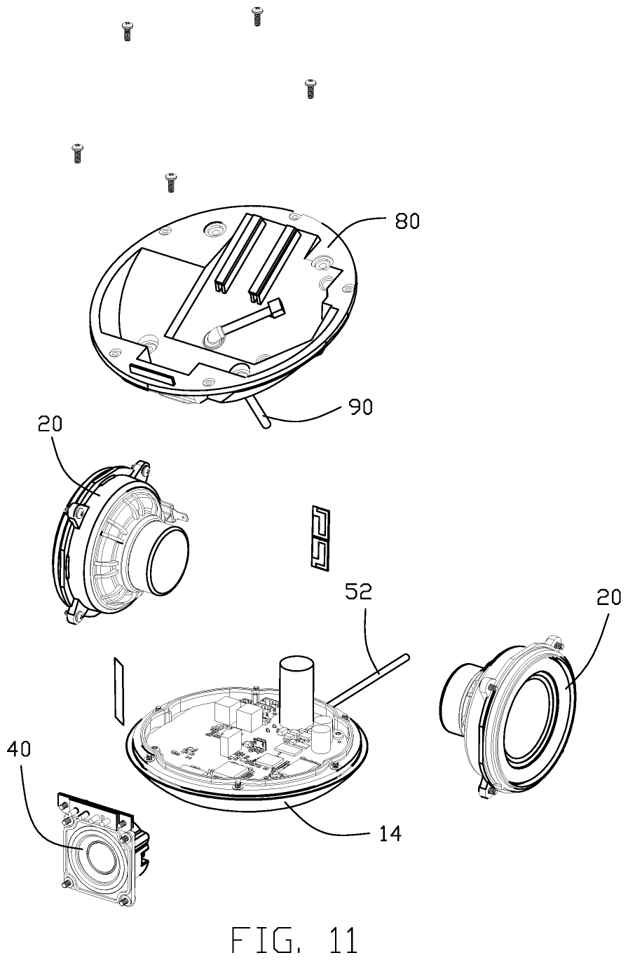

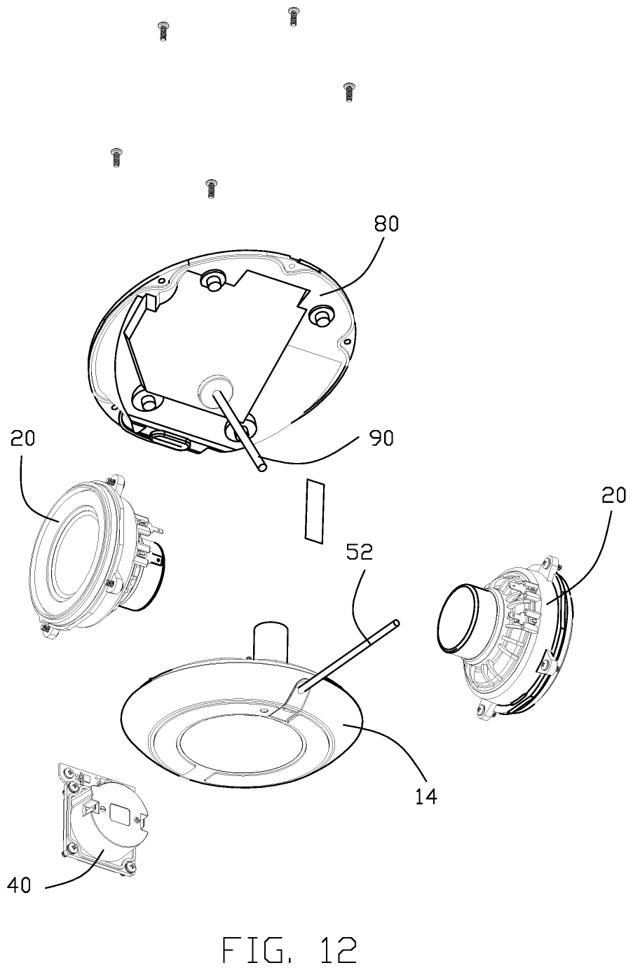

Referring to FIGS. 1-12, a docking speaker 100 includes a hollow case or housing 10 having a tubular main body 12, a base 14 and a ceiling part 16. A pair of push-push woofers or speaker drivers 20 are located around two opposite lateral sides of the case 10, and aligned with and outwardly facing away from each other in the transverse direction. A wireless charging module 30 with a charging coil therein (not shown) is located between the pair of push-push woofers 20 in the transverse direction. A forwardly facing full range speaker or primary speaker driver 40 is located between the pair of push-push woofers 20 in the transverse direction, and not only aligned with and located below the wireless charging module 30 in the vertical direction perpendicular to the transverse direction when viewed along a front-to-back direction perpendicular to both the transverse direction and the vertical direction, but also aligned with and located in front of the wireless charging module 30 in the front-to-back direction when viewed in the vertical direction. A first/main printed circuit board 50 is positioned upon the base 14. A power wire 52 is connected to the first printed circuit board 50 and extends through the base 14 and toward the anterior. The speaker system including the pair of woofers 20 and the full range speaker 40, is controlled by the first printed circuit board 50. A second printed circuit board 60 and the wireless charging module 30 associated therewith, are positioned upon an underside of the ceiling part 16. A third printed circuit board 70 is also positioned on an underside of a panel region 160 of the ceiling part 16 and in front of the second printed circuit board 60 wherein the operation panel region 160 has two through vents 164 aligned with the microphones 74 on the third printed circuit board 70, and marked touching regions between the two vents 164 operated with conductivity switches by finger touch, and the third printed circuit board 70 has pads 72 corresponding to such touching switches. An interior cover 80 is assembled under the ceiling part 16 so as to cooperate with the ceiling part 16 to form therebetween a space in which both the second printed circuit board 60 and the wireless charging module 30 are enclosed. Understandably, both the second printed circuit board 60 and the third printed circuit board 70 are electrically connected to the first printed circuit board 50 via internal wires wherein an internal wire 90 is partially shown. Notably, the ceiling part 16 provides a charging area on the upward seating face 162 on which the cellular phone (not shown) is positioned for wireless charging.

The feature of the invention is to provide the push-push woofers 20 on opposite sides of the case 10 to eliminate the vibration due to the speaker system and the full range/primary speaker 40 and the charging area are located in a center region between the pair of push-push woofers 20 in a symmetrical manner. Accordingly, there is less or even no vibration due to the whole speaker system while playing the music, thus assuring the wireless charging efficiency. Understandably, in this embodiment there is only one wireless charging module between the pair of push-push woofers 20. Anyhow, additional wireless charging modules may be provided as long as the pair of push-push woofers are also symmetrically arranged with regard to such additional wireless charging modules.

What is claimed is:

1. A docking apparatus comprising:
a housing, consisting of one or more parts to commonly form an internal space;
a pair of push-push speaker drivers aligned with and outwardly facing from each other in a transverse direction within or on the housing;
a wireless charging module within or on the housing.

2. The docking apparatus as claimed in claim 1, wherein the pair of push-push speaker drivers are symmetrically arranged with regard to the wireless charging module thereby taking advantage of vibration-canceling properties of the push-push speaker drivers for continuously efficient charging.

3. The docking apparatus as claimed in claim 1, further combined with at least one other speaker driver in addition to the pair of speaker drivers.

4. The docking apparatus as claimed in claim 3, wherein said pair of push-push speaker drivers are symmetrically arranged with regard to said at least one other speaker driver.

5. The docking apparatus as claimed in claim 4, wherein said at least other speaker driver is essentially a full range speaker driver.

6. The docking apparatus as claimed in claim 4, wherein the at least other speaker driver is located below the wireless charging module in a vertical direction perpendicular to the transverse direction.

7. The docking apparatus as claimed in claim 6, wherein the at least other speaker driver is located in front of the wireless charging module in a front-to-back direction perpendicular to both the transverse direction and the vertical direction.

8. The docking apparatus as claimed in claim 4, further including at least one additional wireless charging module.

9. The docking apparatus as claimed in claim 4, wherein viewed along a front-to-back direction perpendicular to the transverse direction, the wireless charging module and the at least one other speaker driver are aligned with each other in a vertical direction perpendicular to both the transverse direction and the front-to-back direction, and viewed along a vertical direction perpendicular to the transverse direction, the wireless charging module and the at least one other speaker driver are aligned with each other in a front-to-back direction perpendicular to both the transverse direction and the vertical direction.

10. The docking apparatus as claimed in claim 1, wherein said one or more parts of the housing includes a main body, a base and a ceiling part.

11. The docking apparatus as claimed in claim 10, wherein the housing is equipped with at least two printed circuit boards to control the pair of push-push speaker driver and the wireless charging module, respectively.

12. The docking apparatus as claimed in claim 11, wherein the printed circuit board controlling the pair of push-push speaker driver is located adjacent to the base, and the printed circuit board controlling the wireless charging module is located adjacent to the ceiling part.

13. The docking apparatus as claimed in claim 12, wherein the ceiling part includes an operation panel region and an oblique seating area behind the panel region, and another printed circuit board is located below the operation panel region, and the printed circuit board controlling the wireless charging module is located under the oblique seating area.

14. The docking apparatus as claimed in claim 11, wherein said at least two printed circuit boards are connected b an internal wire therebetween.

15. The docking apparatus as claimed in claim 11, further including a primary speaker driver located between the pair of push-push speaker drivers, wherein both the pair of push-push speaker driver and the primary speaker driver are commonly controlled by one of said two printed circuit boards.

16. The docketing apparatus as claimed in claim 15, wherein the primary speaker driver faces forwardly in a front-to-back direction perpendicular to the transverse direction.
